(19) United States
(12) Patent Application Publication
(10) Pub. No.: US 2010/0140295 A1
(43) Pub. Date: Jun. 10, 2010

(54) VALVE ASSEMBLIES FOR LIQUID CONTAINERS

(76) Inventor: Emil SHULTIS, Leeds, NY (US)

Correspondence Address: HESLIN ROTHENBERG FARLEY & MESITI PC, 5 COLUMBIA CIRCLE, ALBANY, NY, 12203, US

(21) Appl. No.: 12/575,169

(22) Filed: Oct. 7, 2009

Related U.S. Application Data
(60) Provisional application No. 61/103,349, filed on Oct. 7, 2008.

(51) Int. Cl. B65D 35/56; F16K 15/00; B65D 33/16

(52) U.S. Cl. 222/105; 251/332; 383/42

(57) ABSTRACT

A valve assembly includes, in one embodiment, a housing sealably attachable to a flexible container. The housing has a passageway and an upper stop disposed in the passageway. A plug includes an upper portion having a first peripherally-extending recess, and a lower portion defining a lower stop and at least one passageway extending past the lower portion. A seal is positionable in the recess. A compression spring is disposed between the stops to bias the plug downwardly to engage the seal with an upper opening of the passageway in the housing. The valve assembly has a self-closing position, and an open position upon a force being applied to the bottom portion of the plug so that the seal is disposed away from the upper opening to allow liquid to pass through the passageway in the housing and through the at least one passageway in the lower portion of the plug.

### CROSS-REFERENCE TO RELATED APPLICATION

This application claims the benefit of U.S. Provisional Application No. 61/103,349, filed Oct. 7, 2008, entitled “Valve Assemblies for Liquid Containers,” which application is incorporated in its entirety herein by reference.

### FIELD OF THE INVENTION

This invention relates to liquid dispensing machines, and more particularly to valve assemblies for liquid containers used in liquid dispensing machines such as coffee dispensing machines.

### BACKGROUND OF THE INVENTION

Typically, the production of coffee from liquid coffee concentrate has been limited to commercial devices that are expensive. The liquid coffee concentrate is often contained in flexible bags, which attach to the coffee dispensing machine. Often, the flexible bags are designed for use with a particular coffee dispensing machine.

There is a need for further valve assemblies for liquid containers for use with coffee machines.

### SUMMARY OF THE INVENTION

The present invention provides, in a first aspect, a valve assembly for a container containing a liquid. The valve assembly includes a housing sealably attachable to the container and having a passageway therein extending between an upper opening and a lower opening, and the housing having an upper stop disposed in the passageway. A plug has an upper portion having a first peripherally-extending recess, and a lower portion defining a lower stop and at least one passageway extending past the lower portion. A seal is disposed partially in the first annular recess of the plug, and the seal is sized to correspond to the peripheral edge of the upper opening. A compression spring is disposed between the upper stop and the lower stop to bias the upper portion of the plug downwardly to engage the seal with the upper opening. The valve assembly has a normal self-closing position in which the seal sealably engages the upper opening to prevent the liquid from passing through the passageway in the housing, and a open position upon a force being applied to the bottom portion of the plug to move the upper portion of the plug upwardly so that the seal is disposed away from the upper opening to allow liquid to pass through the passageway in the housing and through the at least one passageway in the lower portion of the plug.

The present invention provides, in a second aspect, a liquid concentrate container which includes a flexible bag, and a valve assembly as noted above attached to the flexible bag.

The present invention provides, in a third aspect, a liquid dispensing machine which includes a liquid container having a valve assembly as noted above and a dispenser having an upper portion having a cutout and an upper peripheral edge engageable with the lower portion of the plug, and the dispenser having a passageway opening into the cutout.

The present invention provides, in a fourth aspect, a method for forming a valve assembly. The method includes providing a housing having a passageway therein extending between an upper opening and a lower opening, and an upper stop disposed in the passageway, providing a plug receivable in the passageway, the plug having an upper portion, a lower portion defining a lower stop, and at least one passageway extending past the lower portion, inserting a biasing means against the upper stop of the housing, inserting the upper portion of the plug though the passageway in the housing so that the lower stop engages the biasing means, applying a force to the plug so that the upper portion of the plug is disposed above the upper opening, positioning a seal on the upper portion of the plug, and removing the force on the plug to seal the upper opening in the housing.

### BRIEF DESCRIPTION OF THE DRAWINGS

The present matter, which is regarded as the invention, is particularly pointed out and distinctly claimed in the concluding portion of the specification. The present invention, however, may best be understood by reference to the following detailed description of various embodiments and the accompanying drawings in which:

FIG. 1 is a perspective view of a liquid dispensing machine such as coffee dispensing machine in accordance with the present invention;

FIG. 2 is a perspective view of the liquid dispensing machine of FIG. 1 in an open position illustrating the flexible bag assemblies containing liquid concentrate;

FIG. 3 is an enlarged elevational view of one of the flexible bags containing liquid concentrate and having a valve assembly in accordance with the present invention;

FIG. 4 is an enlarged, perspective view of the valve assembly of FIG. 3;

FIGS. 5-8 are enlarged, front elevational, side elevational, bottom, and top views, respectively, of the valve assembly of FIG. 4;

FIGS. 9 and 10 are enlarged, cross-sectional views of the valve assembly of FIG. 4, which illustrate a compression spring and an O-ring;

FIG. 11 is an enlarged, exploded, cross-sectional view of the valve assembly of FIG. 4 in a closed position and a dispenser of the dispensing machine of FIG. 1;

FIG. 12 is an enlarged, cross-sectional view of the valve assembly of FIG. 4 in an open position and a dispenser of the dispensing machine of FIG. 1 to allow liquid concentrate to pass through the valve assembly; and

FIG. 13 is cross-sectional view of another embodiment of a valve assembly in accordance with the present invention.

### DETAILED DESCRIPTION OF THE INVENTION

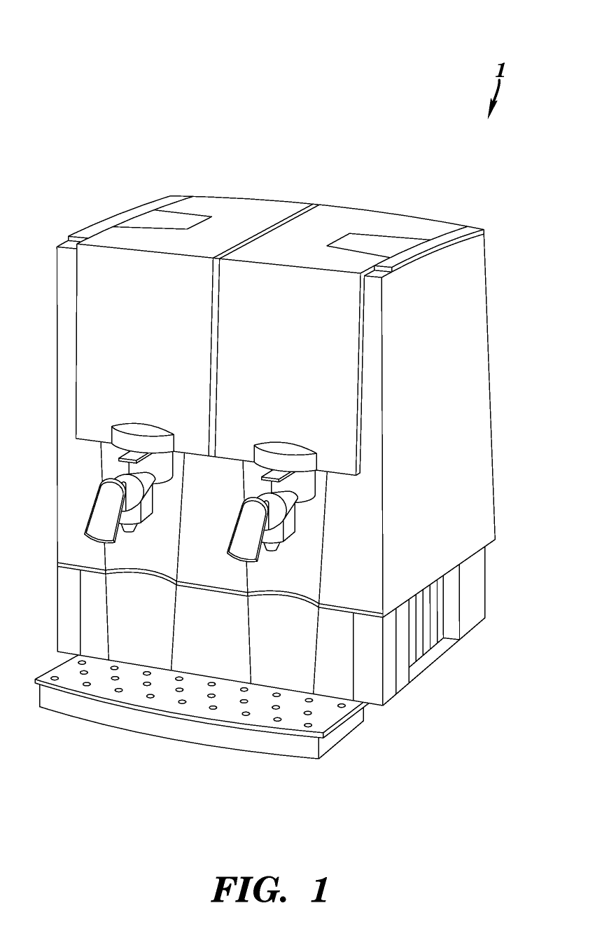

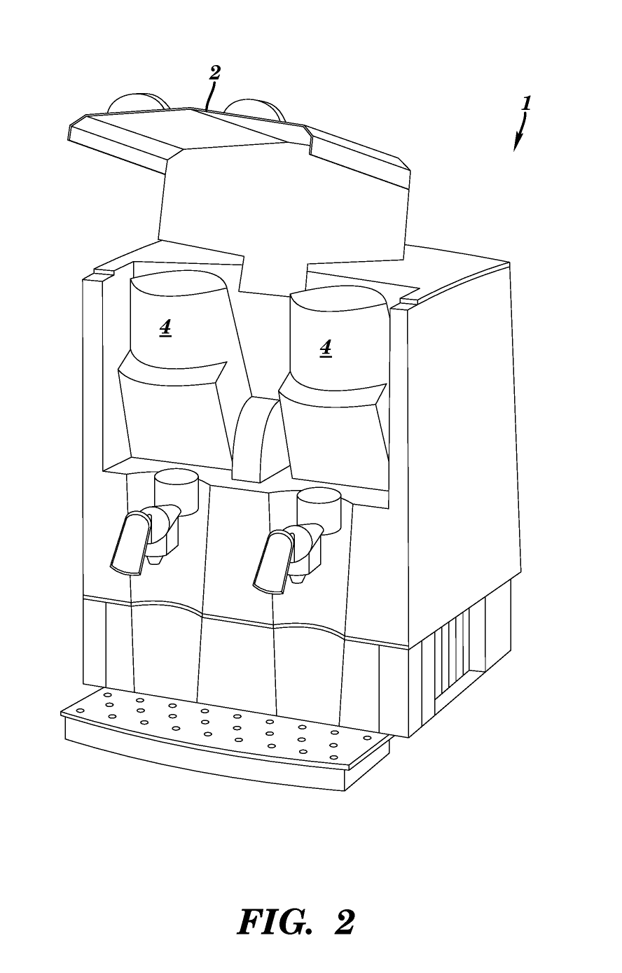

FIGS. 1 and 2 illustrate one embodiment of a liquid dispensing machine 1 such as coffee dispensing machine in accordance with the present invention. For example, as shown in FIG. 2, an upper portion 2 of the liquid dispensing machine 1 may be raised or opened to gain access to flexible bag assemblies 4.

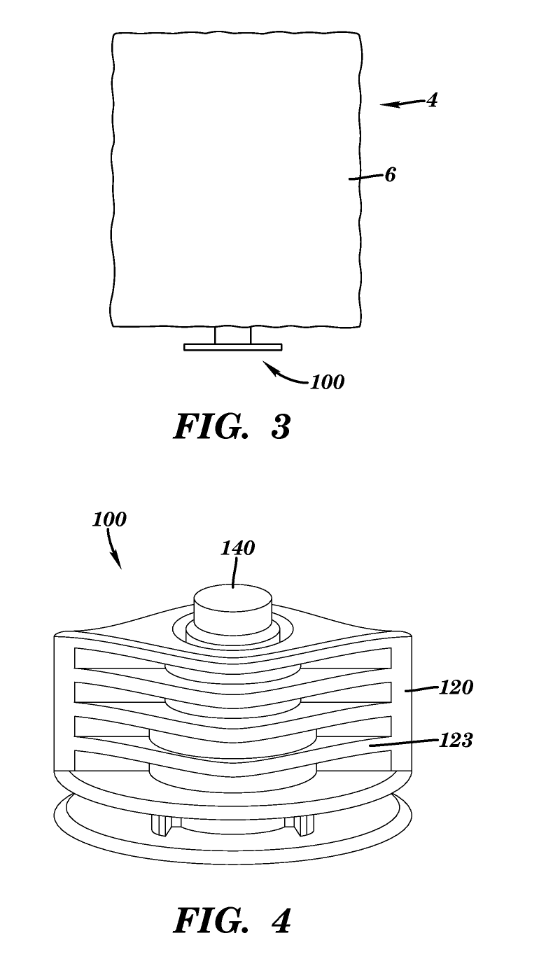

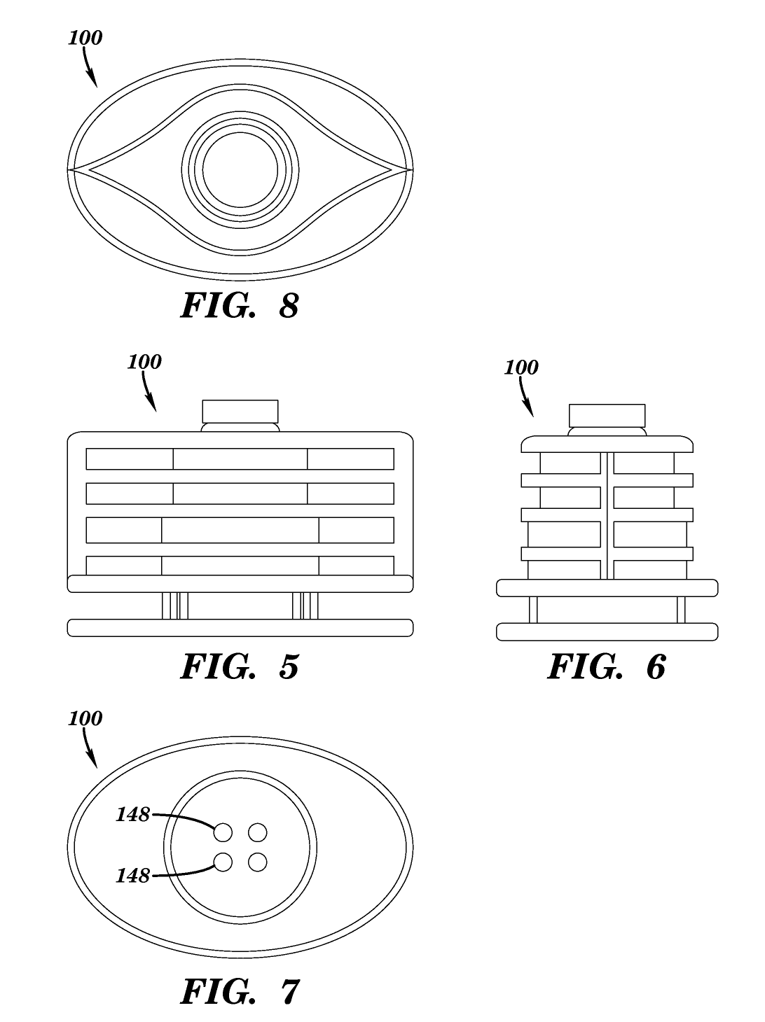

FIG. 3 is an enlarged view of one of flexible bag assemblies 4, which includes a bag 6 and a valve assembly 100 in accordance with the present invention. Valve assembly 100 is operably connectable to the liquid dispensing machine as described in greater detail below. FIG. 4 is an enlarged, perspective view of valve assembly 100, which includes a housing 120 and a sealable plug 140. FIGS. 5-8 are enlarged front elevational, side elevational, bottom, and top views, respectively, of valve assembly 100.

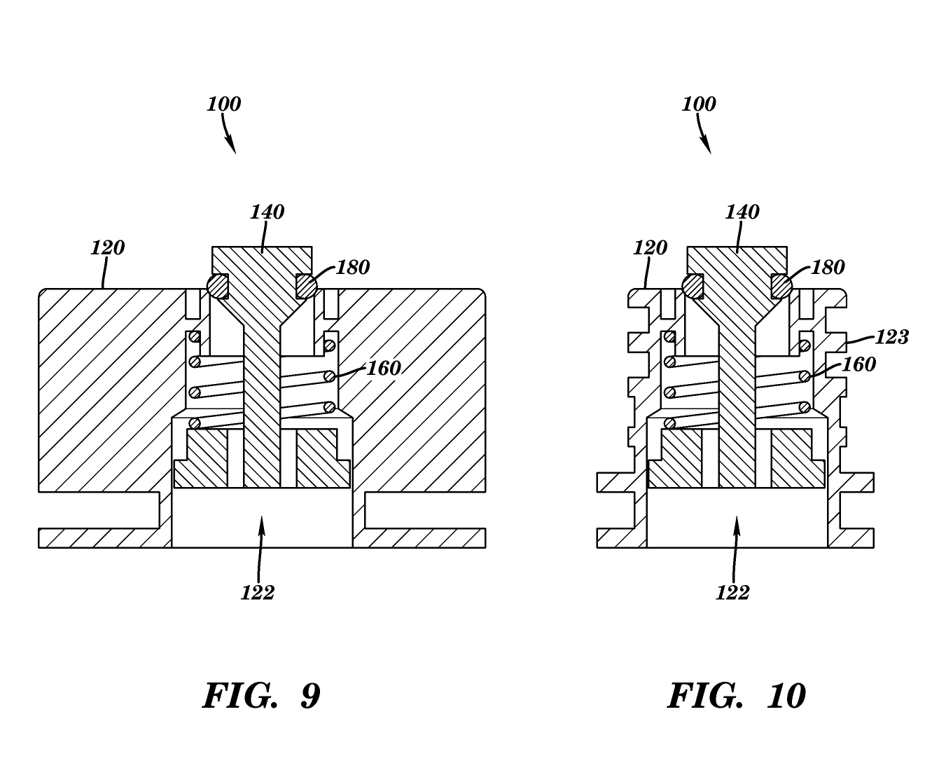

As best shown in FIGS. 9 and 10, valve assembly 100, in addition to housing 120 and plug 140, also includes a compression spring 160 and an O-ring 180. More particularly, the valve assembly is made to be normally self-closing so that the liquid disposed in the bag is inhibited from exiting the valve assembly. The flexible bag may be supplied with liquid therein and with the valve assembly in its normally closed or sealed configuration. In this configuration, liquid concentrate in the flexible bag is inhibited from discharging through valve assembly 100. In addition, when the bag is removed from the dispensing equipment, any remaining liquid in the bag is also inhibited from discharging from the bag.

In valve assembly 100, an outer surface of housing 120 may include a plurality of ribs 123 (FIGS. 10 and 4) which may be sealed to an opening in liquid container 6 (FIG. 3) such as a flexible bag, for example, by heating or ultrasonic welding of the ribs to the sides of the flexible bag. Housing 120 may also include a passageway 122 therein extending between a top surface and a bottom surface of housing 120.

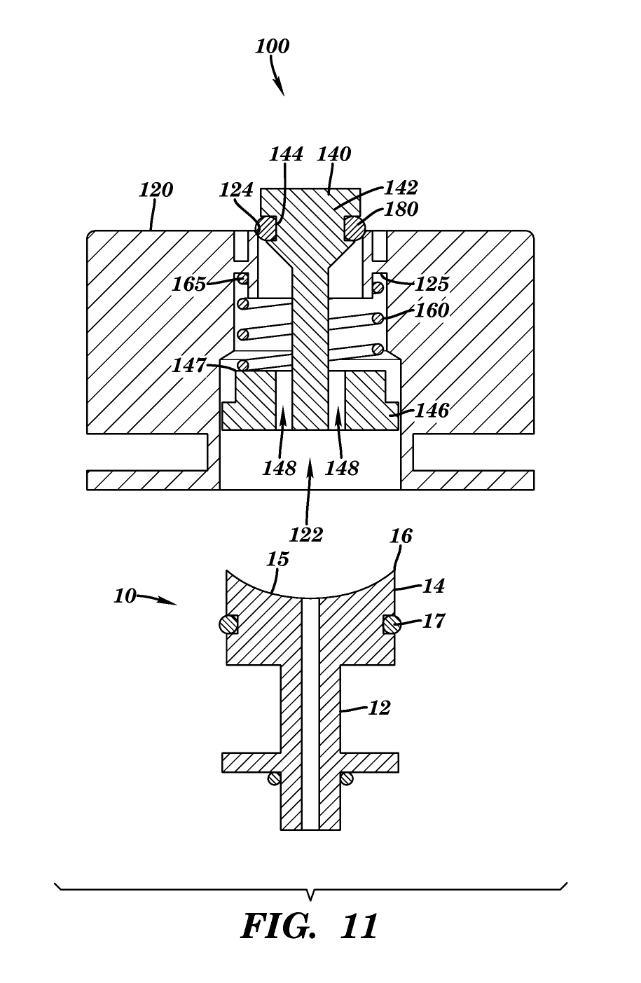

As best shown in FIG. 11, housing 120 includes an upper stop 125 disposed in passageway 122. For example, upper stop 125 may be an annular channel that receives an upper end 165 of spring 160. Plug 140 is receivable in passageway 122 of housing 120 and may include an upper portion 142 such as a solid upper portion having a first recess 144 such as an annular recess, and a lower portion 146 defining a lower stop 147 and at least one passageway 148 extending past lower portion 146. For example, four passageways 148 may be provided as illustrated in FIG. 7. It will be appreciated that the upper portion may have other configuration or be assembled form a plurality of parts so long as the top of the upper portion and the seal, described below, cover the entire opening of the passageway in the housing.

With reference again to FIG. 11, to assemble valve assembly 100, spring 160 is inserted into housing 120 so that upper end 165 of spring 160 is disposed against stop 125. Upper portion 142 of the plug 140 is then inserted through passageway 122 in housing 120 and through spring 160 so that lower stop 147 upper stop 125 compresses spring 160 therebetween, and the upper portion 142 and recess 144 is disposed above an upper opening 124 or protrudes out of housing 120 to expose recess 144. O-ring 180 is then placed in the recess 144, e.g., partially placed in the recess, thus preventing the plug from sliding back through passageway 122 in housing 120 and also creating an airtight seal by seating or compressing a portion of O-ring 180 against the periphery of upper opening 124 in housing 120.

When the flexible bag is inserted in the liquid dispensing machine and connected to a dispenser, liquid coffee concentrate may be made to flow from the bag through the plug, housing, and out the dispenser. For example, in the liquid dispensing machine, liquid coffee concentrate may be mixed with hot water and discharged as a drinkable coffee beverage.

FIG. 11 also illustrates one embodiment of a dispenser 10 in accordance with the present invention along with valve assembly 100. Dispenser 10 of the liquid dispensing machine has a lower end 12, which is received in and normally attaches to suitable structure in the liquid dispensing machine. The upper end 14 of dispenser 10 has a cutout 15 and an upper peripheral edge 16. For example, the cutout may be a concave cutout having a concave surface, and the upper peripheral edge may be circular. From the present description, it will be appreciated that other configurations of the dispenser may be suitable employed. Upper peripheral edge 16 is engageable with the bottom surface of lower portion 146 of plug 140 of valve assembly 100. An O-ring 17 may be disposed around dispenser 10.

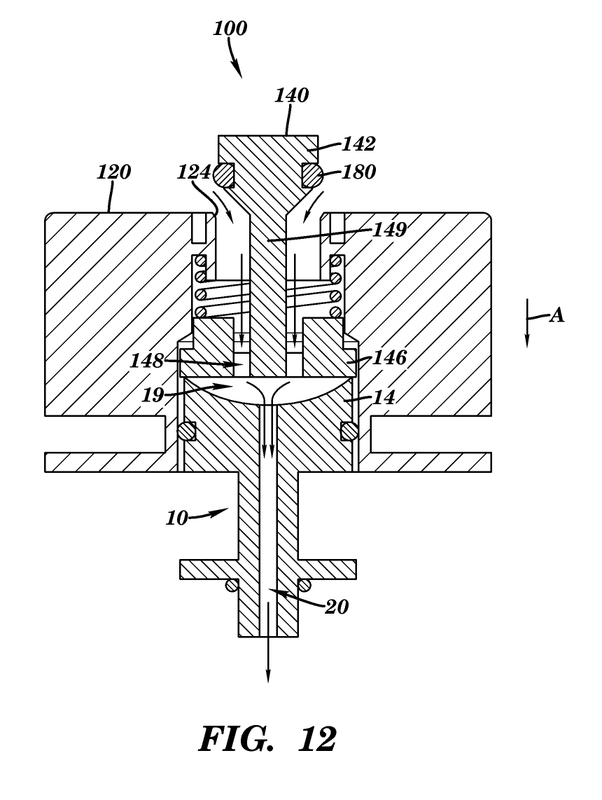

FIG. 12 illustrates the interaction of valve assembly 100 and dispenser 10 to deliver liquid from the liquid container. As shown in FIG. 12, valve assembly 100 is engaged with dispenser 10, for example by valve assembly 100 being moved downwardly in the direction of arrow A towards dispenser 10, so that lower portion 146 of plug 140 engages concave upper portion 14.

As valve assembly 100 is further pushed downwardly onto dispenser 10, plug 140 is pushed upwardly. The upper portion 142 of plug 140 and O-ring 180 extend above the top surface of housing 120. With the O-ring disposed above opening 124, liquid concentrate is permitted to flow down passageway 122 around the middle section of the plug, through passageways 148 in the lower portion of the plug, into a chamber 19 formed between the bottom surface of lower portion 146 of plug 140 and the upper portion 14 of dispenser 10, and through a passageway 20 in dispenser 10 and out the bottom thereof, as shown by the arrows in FIG. 12. Plug 140 may include a middle portion 149 that is sized smaller than upper portion 142 and lower portion 146.

To remove the flexible bag from the dispensing machine, the flexible bag and valve assembly are pulled upwardly. By doing so, the plug is moved to its self-closing sealed position due to the biasing action of spring 160. The flexible bag and valve assembly can then be further pulled upwardly to disengage the flexible bag assembly from dispenser so that the bag can be removed when empty and replaced with a new flexible bag assembly containing liquid concentrate.

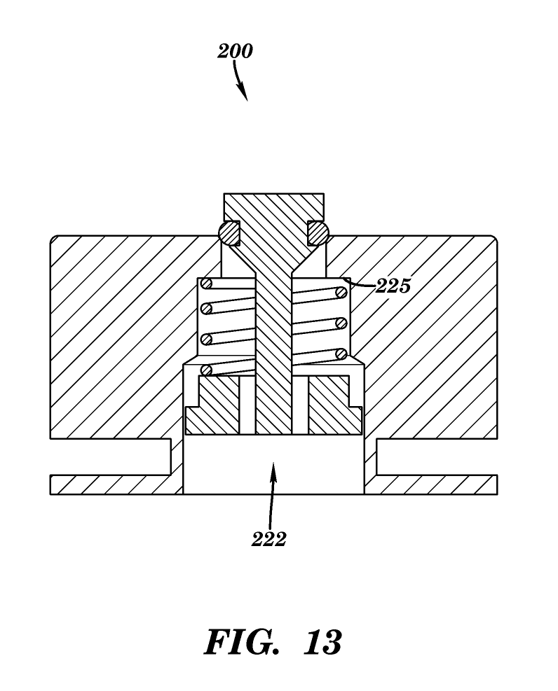

FIG. 13 illustrates another embodiment of a valve assembly 200 in accordance with the present invention. This embodiment is essentially the same as valve assembly 100 with the exception of that the stop 225 may be a ledge or landing disposed in passageway 222. While the passageways are illustrated a being generally round passageways, and the plug being generally cylindrical, it will be appreciated that the passageway and plug may have other suitable configurations.

From the present description, the valve assembly may be made to remain in a fixed position in the liquid dispensing machine and the dispenser made to move upwardly and downwardly relative to the valve assembly when installing or removing the flexible bag. In addition, a separate dispensing handle or assembly on the dispensing machine may be provided for ultimately controlling the discharge of the mixture of liquid concentrate and dilutent from the dispensing machine. When the user activates a handle on the coffee machine to obtain a cup of coffee, the liquid concentrate and a dilutent may be discharged from coffee machine. The dispenser, valve assembly, and the plug may be formed from a plastic material or other suitable materials. The O-rings may be formed from a rubber, silicon, or other suitable material. The spring may be a stainless steel spring.

Although various embodiments have been depicted and described in detail herein, it will be apparent to those skilled in the relevant art that modifications, additions, substitutions and the like can be made without departing from the spirit of the present invention and these are, therefore, considered to be within the scope of the present invention.

1. A valve assembly for a container containing a liquid, said valve assembly comprising:
a housing sealably attachable to the container and having a passageway therein extending between an upper opening and a lower opening, said housing having an upper stop disposed in the passageway;
a plug having an upper portion having a first peripherally-extending recess, and a lower portion defining a lower stop and at least one passageway extending past said lower portion;
a seal disposed partially in said first annular recess of said plug, said seal sized to correspond to the peripheral edge of said upper opening;
a compression spring disposed between said upper stop and said lower stop to bias said upper portion of said plug downwardly to engage said seal with said upper opening; and
wherein said valve assembly has a normal self-closing position in which said seal sealably engages said upper opening to prevent the liquid from passing through said passageway in said housing, and a open position upon a force being applied to said bottom portion of said plug to move said upper portion of said plug upwardly so that said seal is disposed away from said upper opening to allow liquid to pass through said passageway in said housing and through said at least one passageway in said lower portion of said plug.

2. The valve assembly of claim 1 wherein said at least one passageway comprises a plurality of passageways extending through said lower portion of said plug.

3. The valve assembly of claims 1 wherein said upper stop comprises an annular stop for receiving an upper end of said spring.

4. The valve assembly of claim 1 wherein said peripheral-extending recess comprises an annular recess.

5. The valve assembly of claim 1 wherein said seal comprises an O-ring.

6. The valve assembly of claim 1 wherein said plug comprises a middle portion having a cross-section smaller than said upper portion and said lower portion.

7. A liquid concentrate container comprising:
a flexible bag; and
a valve assembly of claim 1 attached to said flexible bag.

8. The liquid concentrate container of claim 7 further comprising a liquid concentrate contained in said flexible bag.

9. A liquid dispensing machine comprising:
a liquid container having a valve assembly of claim 1; and
a dispenser having an upper portion having a cutout and an upper peripheral edge engageable with said lower portion of said plug, and said dispenser having a passageway opening into said cutout.

10. The liquid dispensing machine of claim 9 wherein said cutout comprises a concave surface.

11. A method for forming a valve assembly, the method comprising
providing a housing having a passageway therein extending between an upper opening and a lower opening, and an upper stop disposed in the passageway;
providing a plug receivable in the passageway, the plug having an upper portion, a lower portion defining a lower stop, and at least one passageway extending past the lower portion;
inserting a biasing means against the upper stop of the housing;
inserting the upper portion of the plug though the passageway in the housing so that the lower stop engages the biasing means;
applying a force to the plug so that the upper portion of the plug is disposed above the upper opening;
positioning a seal on the upper portion of the plug; and
removing the force on the plug to seal the upper opening in the housing.

12. The method of claim 11 wherein the at least one passageway comprises a plurality of passageways extending through the lower portion of the plug.

13. The method of claims 11 wherein the upper stop comprises an annular stop for receiving an upper end of the spring.

14. The method of claim 11 wherein the peripheral-extending recess comprises an annular recess.

15. The method of claim 11 wherein the seal comprises an O-ring.

16. The method of claim 11 wherein the plug comprises a middle portion having a cross-section smaller than the upper portion and the lower portion.
